(19) United States
(12) Patent Application Publication
(10) Pub. No.: US 2020/0351179 A1
(43) Pub. Date: Nov. 5, 2020

(54) Methods, Network Function Entities and Computer Readable Media for Providing IoT Services

(71) Applicant: Telefonaktiebolaget LM Ericsson (publ), Stockholm (SE)

(72) Inventors: Zhancang Wang, Beijing (CN); Bo Zhong, Beijing (CN)

(21) Appl. No.: 16/957,134

(22) PCT Filed: Dec. 29, 2017
(86) PCT No.: PCT/CN2017/119900

§ 371 Date: Jun. 23, 2020

(51) Int. Cl. H04L 12/24; H04L 29/06; H04W 12/06

(52) U.S. Cl. CPC H04L 41/5041; H04L 69/08; G16Y 30/10; H04W 12/06; H04L 63/0876

(57) ABSTRACT

The present disclosure provides methods for providing an Internet of Things (IoT) service from a cloud node to an IoT network device in a cloud computing environment comprising a plurality of sub-cloud nodes. The method comprises receiving a first service request to invoke at least one service; selecting one of the plurality of cloud nodes as a serving node for the at least one service based on the first service request; determining one or more IoT network device to receive the at least one service based on the first service request; and transmitting data of the at least one service from the serving node to the determined IoT network device. The present disclosure further discloses a corresponding method which comprises receiving data of the IoT service from a cloud node, and transmitting the data to the terminal device to which it is connected. The present disclosure further provides corresponding NF entities and computer readable medium.

### TECHNICAL FIELD

The present disclosure generally relates to the technical field of telecommunication, and particularly to methods and Network Function (NF) entities for providing an Internet of Things (IoT) service in a flattened IoT network architecture, and corresponding computer readable media.

### BACKGROUND

This section is intended to provide a background to the various embodiments of the technology described in this disclosure. The description in this section may include concepts that could be pursued, but are not necessarily ones that have been previously conceived or pursued. Therefore, unless otherwise indicated herein, what is described in this section is not prior art to the description and/or claims of this disclosure and is not admitted to be prior art by the mere inclusion in this section.

With the rapid developing growth of information technology and communication, the devices equipped with various network functions connecting each other are more popular. To efficiently manage those devices, the Internet of Thing (IoT) technology is adopted. The IoT network is an emerging concept of the network which allows any object in the real world is connected at anytime and anywhere through the integration of object identification, interaction, and information sensing technologies.

Therefore, the IoT network concept refers to the network of physical objects with Internet connectivity, and the communication between such objects and other Internet-enabled devices and systems. The IoT network extends Internet connectivity beyond traditional devices to a range of devices and everyday things that may utilize embedded technology to communicate and interact with an external environment via the Internet.

### SUMMARY

At least some objects of the present disclosure are to propose a flattened IoT architecture, in which a new network device for connecting the sensing device domain and the cloud domain is provided.

According to one aspect of the present disclosure, there is provided a method for providing an Internet of Things (IoT) service from a cloud node to an IoT network device in a cloud computing environment comprising a plurality of sub-cloud nodes. The method comprises receiving a first service request to invoke at least one service; selecting one of the plurality of cloud nodes as a serving node for the at least one service based on the first service request; determining one or more IoT network device to receive the at least one service based on the first service request; and transmitting data of the at least one service from the serving node to the determined IoT network device. The IoT network device is connected to one or more terminal device which uses the data of the at least one service.

In an exemplary embodiment, the first service request is from a service provider.

In an exemplary embodiment, each of the plurality of cloud nodes is assigned with a specific type of service.

In an exemplary embodiment, the first service request indicates specific terminal device functions for the at least one service.

In an exemplary embodiment, the method further comprises receiving terminal device data from the IoT network device for the at least one service. The terminal device data is collected by the IoT network device from the terminal device to which it connects.

In an exemplary embodiment, the method further comprises processing the terminal device data according to the at least one service.

In an exemplary embodiment, the method further comprises receiving a second service request from the IoT network device, which second service request indicates a specific event; and initiating a second service based on the second service request.

In an exemplary embodiment, the IoT network device has at least one of usage information of the terminal device, and state information of the terminal device.

In an exemplary embodiment, the IoT network device further comprises a profile of a service provider.

In an exemplary embodiment, the method further comprises, prior transmitting the data of the at least one service to the IoT network device: generating data of the at least one service according to a protocol agreed between the serving node and the IoT network device.

In an exemplary embodiment, selecting one of the plurality of cloud nodes as the serving node comprises: determining a catalog/index of the at least one service; and selecting one of the plurality of cloud nodes based on the catalog/index of the at least one service.

In an exemplary embodiment, the method further comprises receiving a first authentication request including at least an identification of the IoT network device and an identification of the terminal device from the IoT network device, performing an authentication on the first authentication request, and transmitting an authentication result to the IoT network device.

In an exemplary embodiment, the authentication result comprises a Disable command to disable the terminal device.

In an exemplary embodiment, the method further comprises transmitting a Re-authentication indication to the IoT network device after transmitting the Disable command.

According to another aspect of the present disclosure, there is provided a method for communicating an IoT service with a terminal device at an IoT network device to which the terminal device is connected. The method comprises receiving data of the IoT service from a cloud node, and transmitting the data to the terminal device to which it is connected.

In an exemplary embodiment, the data of the IoT service indicates a terminal device as a target, and the method further comprises: processing the data according to the indicated target; and transmitting the processed data to the target terminal device.

In an exemplary embodiment, the terminal device comprises at least one of an Accelerometer, a Thermometer, a Hygrometer, A gyroscope, an Ambient Light detector, a MEMS microphone, a Magnetometer, and a Barometer.

In an exemplary embodiment, the method further comprises collecting data from the terminal device; and transmitting the collected data to the cloud node.

In an exemplary embodiment, the method further comprises transmitting a second service request to the cloud node, which second service request indicates a specific event.

In an exemplary embodiment, the method further comprises, prior to transmitting the collected data: transmitting a third service request to the cloud node, which third service request includes at least an identification of a service, an identification of the terminal device, an identification of the IoT network device, and transmitting the collected data if an approval of the service is received in response to the transmission of the third service request.

In an exemplary embodiment, the method further comprises transmitting a first authentication request including at least an identification of the IoT network device and an identification of the terminal device to the cloud node, and receiving an authentication result in response to the transmission of the first authentication request.

In an exemplary embodiment, the method further comprises entering an inactive state and indicating the inactive state to the terminal device in case that the authentication result indicates a failed authentication.

In an exemplary embodiment, the method further comprises re-activating for a short period in the inactive state; and In the case that a re-authentication indication is received during the re-activating period: transmitting a second authentication request including an identification of the IoT network device and an identification of the terminal device to the cloud node and receiving an authentication result in response to the transmission of the second authentication request.

According to still another aspect of the present disclosure, there is provided a NF entity for providing an IoT service from a cloud node to an IoT network device in a cloud computing environment comprising a plurality of sub-cloud nodes. The NF entity comprises a communication interface arranged for communication, at least one processor, and a memory comprising instructions which, when executed by the at least one processor, cause the NF entity to: receive a first service request to invoke at least one service; select one of the plurality of cloud nodes as a serving node for the at least one service based on the first service request; determine one or more IoT network device to receive the at least one service based on the first service request; and transmit data of the at least one service from the serving node to the determined IoT network device. The IoT network device is connected to one or more terminal device which uses the data of the at least one service.

According to yet another aspect of the present disclosure, there is provided a NF entity for communicating an IoT service with a terminal device at an IoT network device to which the terminal device is connected. The NF entity comprises a communication interface arranged for communication, at least one processor, and a memory comprising instructions which, when executed by the at least one processor, cause the NF entity to: receive data of the IoT service from a cloud node, and transmit the data to the terminal device to which it is connected.

According to the above technical solutions of the present disclosure, a could computing environment which has an intensive computing and processing capability is used as the cloud domain and a new network device for connecting the sensing device domain and the cloud domain is provided. The IoT network is thus flattened compared with the existing network. It may provide highly efficient node management when the network scale becomes very large.

### BRIEF DESCRIPTION OF THE DRAWINGS

The objects, advantages and characteristics of the present disclosure will be more apparent, according to descriptions of preferred embodiments in connection with the drawings, on which:

FIG. 1 illustrates an IoT architecture according to an embodiment of the present disclosure;

FIG. 2 illustrates a topology of the present disclosure, where (a) shows the topology of the connection between a cloud computing environment and cloud nodes, and (b) shows the topology of the various components in the IoT network according to the present disclosure;

FIG. 3 illustratively shows a flowchart of a method 300 for providing an IoT service from a cloud node to an IoT network device in a cloud computing environment according to an exemplary embodiment of the present disclosure;

FIG. 4 shows an exemplifying signaling diagram illustrating details of the authentication process according to an embodiment of the present disclosure;

FIG. 5 illustratively shows a flowchart of a method 500 for communicating an IoT service with a terminal device according to an exemplary embodiment of the present disclosure;

FIG. 6 illustratively shows a schematic structure diagram of an NF entity according to an exemplary embodiment of the present disclosure;

FIG. 7 illustratively shows a schematic structure diagram of an NF entity according to an exemplary embodiment of the present disclosure; and

FIG. 8 illustrates three exemplary implementations of a network node (NN) according to the present disclosure.

It should be noted that throughout the drawings, same or similar reference numbers are used for indicating same or similar elements; various parts in the drawings are not drawn to scale, but only for an illustrative purpose, and thus should not be understood as any limitations and constraints on the scope of the present disclosure.

### DETAILED DESCRIPTION

Hereinafter, the principle and spirit of the present disclosure will be described with reference to illustrative embodiments. Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

In the following description, numerous specific details are set forth with respect to one or more embodiments of the present patent disclosure. However, it should be understood that one or more embodiments may be practiced without such specific details. In other instances, well-known circuits, subsystems, components, structures and techniques have not been shown in detail in order not to obscure the understanding of the example embodiments. Accordingly, it will be appreciated by one skilled in the art that the embodiments of the present disclosure may be practiced without such specific components. It should be further recognized that those of ordinary skill in the art, with the aid of the Detailed Description set forth herein and taking reference to the accompanying drawings, will be able to make and use one or more embodiments without undue experimentation.

References in this specification to “one embodiment,” “an embodiment,” “an example embodiment,” etc. indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of the skilled in the art to affect such feature, structure, or characteristic in connection with other embodiments whether or not explicitly described.

The terminology used herein is for the purpose of describing particular embodiments only and is not intended to be liming of exemplary embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

Currently, a typical IoT network contains three domains, i.e., sensing device domain, network domain, and cloud domain. This kind of network topology is taken as the classical IoT architecture. In the network, elements such as IoT nodes, device gateway, cellular network, wireless local network (WLAN) network, ZigBee network and IoT service gateway bridge the front end to the back end.

The network domain is complicated in the classical IoT architecture, which may cause difficulty in network scale expansion (especially for a large scale network) and flexibility when, for example, the IoT network needs to adapt quickly to changing requirements of the environment.

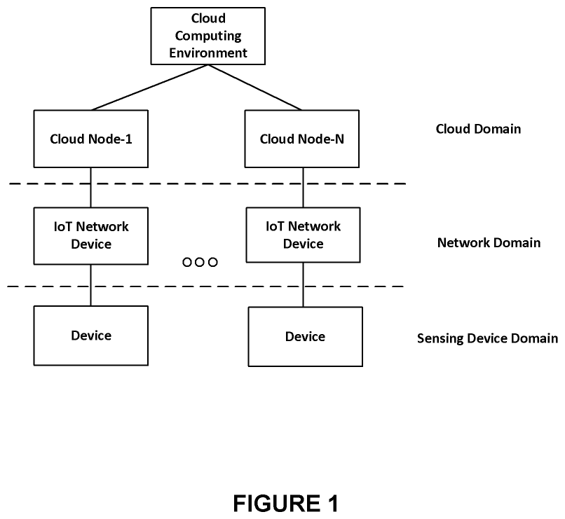

FIG. 1 illustrates an IoT architecture according to an embodiment of the present disclosure.

The cloud computing environment is one in which large groups of remote servers are networked to allow centralized data storage and online access to computer services or resources. This converged infrastructure enables shared services between a number of users. Cloud computing environment may be used to implement a variety of computational paradigms, such as virtual machine, jobs, remote procedure calls, traditional servers, etc.

Cloud computing resources can be not only shared by multiple users but are also dynamically allocated per demand. It is known to provide a resource scheduler that is configured to allocate cloud computing resources between users upon request.

As shown in FIG. 1, the present disclosure uses the cloud computing environment as the cloud domain to provide centralized management and provide various services or applications (such as IoT applications) in the IoT network.

When an application provider provides a service by proposing its service description to the cloud computing environment, the cloud computing environment determines resources to be allocated for the service, such as computing capability, storage capacity, and others. The cloud computing environment then assigns the determined resources to the service, which resources are called a cloud node hereinafter. That is, a cloud node is a collection of resources that are assigned to a specific service. For a massive IoT network, there may be enormous applications and services for providing services to terminal devices in the network. Accordingly, the cloud computing environment may comprise a plurality of cloud nodes for providing various services to the terminal devices. The cloud computing environment plays a role to regulate, allocate resource and manage the cloud nodes.

As shown in FIG. 1, the present disclosure uses an IoT network device as the network domain to provide a channel for data transmission between a cloud node and a terminal device. The IoT network device according to the present disclosure is used as a hub of terminal devices, a protocol conversion platform and also an information flow platform. One IoT network device may connect to/support a plurality of terminal devices. The terminal devices in an IoT network may be, by way of example and not limitation, various sensors, including for example an Accelerometer, a Thermometer, a Hygrometer, A gyroscope, an Ambient Light detector, a MEMS microphone, a Magnetometer, and a Barometer, or a User Equipment (UE), a SS (Subscriber Station), a Portable Subscriber Station (PSS), a Mobile Station (MS), a Mobile Terminal (MT) or an Access Terminal (AT). The UE may include, but not limited to, mobile phones, cellular phones, smart phones, or personal digital assistants (PDAs), portable computers, image capture terminal devices such as digital cameras, gaming terminal devices, music storage and playback appliances, wearable terminal devices, vehicle-mounted wireless terminal devices and the like. The term “terminal device” is used herein to refer any device that is connected to the IoT network and uses the IoT service.

The terminal devices may connect to the IoT network device via a hard wire, a wireless network, a wired connection, etc. The connection between the terminal devices and the IoT network device is not limited in the present disclosure. The terminal devices may even be hot plugged to the IoT network device, or integrated in the IoT network.

The IoT network device according to the present disclosure is used as an information flow platform between the cloud domain and the sensing device domain. That is, information is transmitted from a terminal device to the cloud domain or from the cloud domain to the terminal device via an IoT network device to which the terminal device is connected/integrated there.

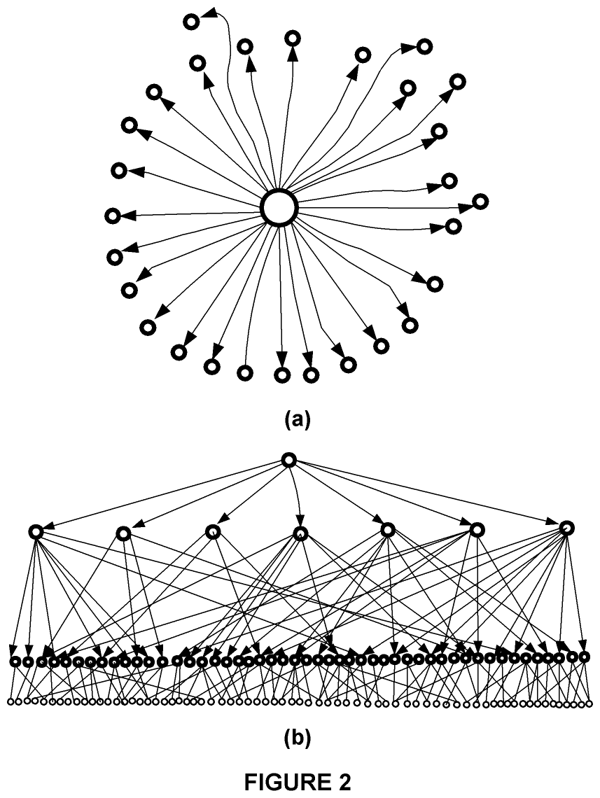

FIG. 2 illustrates a topology of the present disclosure, where (a) shows the topology of the connection between a cloud computing environment and cloud nodes, and (b) shows the topology of the various components in the IoT network according to the present disclosure. As shown in FIG. 2(a), the topology between cloud nodes and the central cloud computing environment is depicted as a “star” topology. As shown in FIG. 2(b), a flattened network topology is proposed according to the present disclosure, where the top two layers are the central cloud computing environment and the cloud nodes, and the third layer is the layer of IoT network devices, which connect to the lowest layer of terminal devices. A cloud node provides an IoT service which may involve more than one terminal device data. For example, a traffic service (or application) may need to collect traffic data and may also need to collect whether data so as to predict the factor that might affect the traffic. In such a case, a cloud node that provides the traffic service may need to collect data from the IoT network devices which in turn collect traffic data from terminal devices they connect and also need to collect data from other IoT network devices which in turn collect whether data from terminal devices they connect. Similarly, an IoT network device may support and serve several terminal devices. There is no interaction between terminal devices. Accordingly, the connection between the cloud nodes and the IoT network devices, and the connection between the IoT network devices and the terminal devices are meshy, as shown in FIG. 2(b). However, as can be seen from FIG. 2, the network topology according to the present disclosure contains fewer layers than prior art and enhances large-scale network operation efficiency.

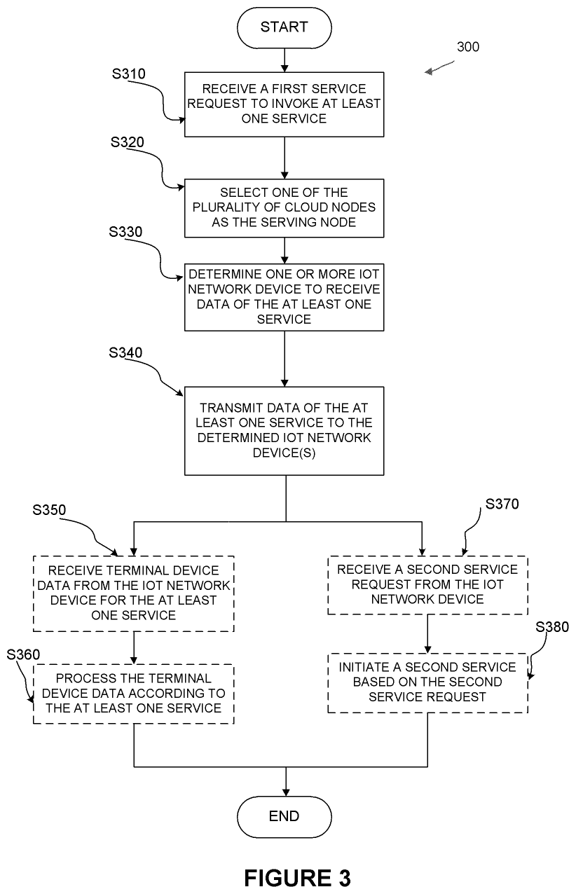

FIG. 3 illustratively shows a flowchart of a method 300 for providing an IoT service from a cloud node to an IoT network device in a cloud computing environment according to an exemplary embodiment of the present disclosure. The cloud computing environment may comprise a plurality of cloud nodes. In an embodiment, the method 300 may be performed at the cloud domain.

As shown in FIG. 3, the method 300 may include blocks S310˜S380.

The method 300 starts at block S310, where a first service request to invoke at least one service is received. The first service request may come from a service provider to invoke a service offered in the IoT network.

Thereafter, in block S320, one of the plurality of cloud nodes is selected as the serving node for the at least one service based on the first service request received in block S310. In an embodiment, the first service request may comprise the identification of the at least one service to be invoked, or an identification of the service provider. Each cloud node is mapped to/assigned with a specific type of service. Accordingly, the corresponding cloud node that is involved in the at least one service may be determined based on the first service request. In another example, the first service request may invoke more than one service, which may result in selection of more than one cloud nodes. In an embodiment of the present disclosure, each service may have its own catalog/index. A catalog/index of the at least one service may be determined and then one of the plurality of cloud nodes is selected based on the catalog/index of the at least one service.

The method then proceeds to block S330, where one or more IoT network device to receive the data least one service is determined based on the first service request. According to the at least one service indicated by the first service request, the terminal devices that are involved in the at least one service may be determined. In the cloud computing environment, information on IoT network devices and on terminal devices has been previously stored. For example, when an IoT network device initially connects to the IoT network, it will transmit to the cloud computing environment its information and information on terminal devices that connect to it. Alternatively, when a new terminal device is connect to the network by connecting to an IoT network device, the IoT network device to which it connects will transmit its information and information on that terminal devices to the cloud computing environment. When a service is initially established/provided in the IoT network, the cloud computing environment may analyze the service to determine the terminal devices (and also the IoT network devices) that may be involved in the service. Then, the relationship between the service and the terminal devices and also the IoT network devices is established. The relationship may be a mapping table, a manifest, a file, and others. It is not limited in the present disclosure. When the at least one service is to be invoked upon receiving the first service request, the IoT network device to receive data of the at least one service can be determined based on the relationship.

The method proceeds to block S340, where data of the at least one service is transmitted from the serving node to the determined IoT network device. In the present disclosure, the IoT network device is connect to one or more terminal device which uses the data of the at least one service.

In an embodiment of the present disclosure, prior to block S340 of transmitting the data of the at least one service to the IoT network device, the cloud node may be operative to generate data of the at least one service according to a protocol agreed between the serving node and the IoT network device. By using a uniform protocol between the cloud node and the IoT network device, there is no more intermediate elements needed for the IoT network device to correctly receive the data. For example, no gateway device is needed for protocol conversion. The cloud computing environment has an intensive computing and processing capability. The present disclosure makes use of that capability of the cloud domain to flatten the network.

In an embodiment of the present disclosure, the first service request may indicate specific terminal device functions for the at least one service. For example, the first service request is to invoke a traffic service, and is to broadcast traffic regulation messages to a specific city. The cloud node that is assigned with the traffic service is selected from the plurality of cloud nodes. The IoT network devices that are in the specific city and connect to vehicle navigators may be determined to receive the traffic regulation messages. The traffic regulation messages are then transmitted from the cloud node to the IoT network devices, which will display the received messages on the display of the vehicle navigators to which they connect.

Returning to FIG. 3, in an embodiment of the present disclosure, the method 300 may further comprise block S350 of receiving terminal device data from the IoT network device for the at least one service. The terminal device data is collected by the IoT network device from the terminal device to which it connects. For example, the first service request is to invoke a traffic service, and needs to collect the position information of all vehicles in a specific city. The IoT network device, upon receiving data of the service from the serving node, knows that it needs to collect position information by analyzing the received service data. Then the IoT network device may initiate a location sensor to which it connects to sense the location, and transmits the position information to the cloud node which provides the traffic service. In the embodiment of the present disclosure, the method 300 may further comprise block S360 of processing the terminal device data according to the at least one service. For example, the cloud node which receives the position information from the IoT network device may process and analyze all the position information from IoT network devices in a specific city, to generate a traffic analysis result or a traffic jam analysis. The cloud node may also report the processed result to the service provider.

In an embodiment of the present disclosure, the method 300 may further comprise block S370 of receiving a second service request from the IoT network device. The second service request indicates a specific event. The method 300 may also comprise block S380 of initiating a second service based on the second service request. In some cases, the terminal device data collected by the IoT network device indicates a specific event, such as a malfunction of the terminal device, an unauthorized usage of a device, an abnormal condition, and others. For example, a temperature sensor in a room temperature reports a temperature of −20 Celsius degrees, which might mean that the temperature sensor may fail. As another example, a temperature sensor in a room temperature reports a temperature of 90 Celsius degrees, which indicates that there may be a fire near the temperature sensor. In an embodiment of the present disclosure, the IoT network device has at least one of usage information of the terminal device and state information of the terminal device. When receiving terminal device data from the terminal device, the IoT network device may determine whether a specific event occurs. If a specific event occurs, the IoT network device transmits a second service request to the cloud node, indicating the specific event. The cloud node which receives the second service request may initiate a corresponding second service to handle the event. For example, if a plurality of second service requests is received indicating the temperature around a place is higher than 80 Celsius degrees, the cloud node may initiate a fire alarm service to inform the fire. For example, a message indicating the place and the range of the fire may be transmitted to a fire control center. As another example, if the cloud node receives a second service request indicating a malfunction of the temperature sensor, the cloud node may initiate an alarm service. The IoT network device may then flicker or show a message on its display to indicate the malfunction of the temperature sensor to a user of the temperature sensor, who may replace the temperature sensor.

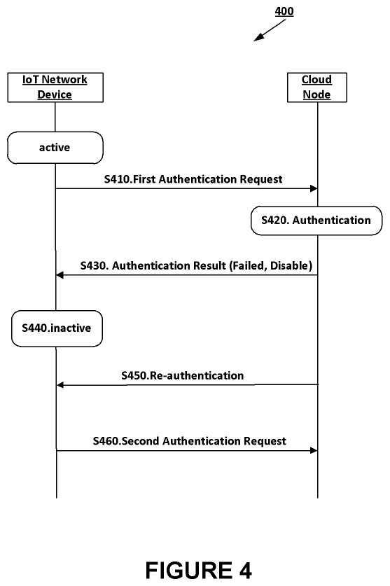

In an embodiment of the present disclosure, the method 300 may further comprise an authentication process between the cloud node and the IoT network device. FIG. 4 shows an exemplifying signaling diagram illustrating details of the authentication process according to an embodiment of the present disclosure. When a terminal device or an IoT network device initially connects to the IoT network, it initiates an authentication process. In another case, when a terminal device transmits data to the cloud node via the IoT network device to activate a specific service, an authentication process is needed before the specific service is activated. As shown in FIG. 4, in block S410, the cloud node receives a first authentication request including at least an identification of the IoT network device and an identification of the terminal device from the IoT network device. In an embodiment of the present disclosure, the IoT network device may further comprise a profile of a service provider (or a service) (which may be received in block S340), and include the profile of the service provider in the first authentication request, to indicate an authentication aiming at the specific service provider (or, a specific service). Then in block S420, the cloud node performs an authentication on the first authentication request, and transmits an authentication result to the IoT network device in block S430. If the authentication result indicates a successful authentication, the terminal device and the IoT network device are allowed to anticipate in the service. With the authentication process, only verified terminal devices and IoT network devices are allowed to get access the service. For example, a stolen cell phone cannot register to applications. The IoT network device may enter an inactive state (S440) and indicate the inactive state to the terminal device in case that the authentication result indicates a failed authentication. In an embodiment of the present disclosure, if the authentication result indicates an unsuccessful authentication, the authentication result may comprise a Disable command to disable the terminal device. For example, a stolen cell phone may be disabled with the Disable command included in the authentication result. As another example, the cloud node may transmit, in block S450, a Re-authentication indication to the IoT network device after transmitting the Disable command. In some cases, the first unsuccessful authentication may be resulted from some abnormal situations. For example, a malfunction of the terminal device may result in unsuccessful authentication. The cloud node may transmit a Re-authentication indication to invite another authentication process. The IoT network device may reactivate for a short period in the inactive state. In the case that a re-authentication indication is received during the re-activating period, the IoT network device may transmit, in block S460, a second authentication request including an identification of the IoT network device and an identification of the terminal device to the cloud node and receive an authentication result in response to the transmission of the second authentication request. For example, after recovery of the terminal device, the IoT network device that receives the Re-authentication indication may re-transmit an authentication request including the identification of the IoT network device and the identification of the terminal device to the cloud node, to request authentication on the IoT network and the terminal device.

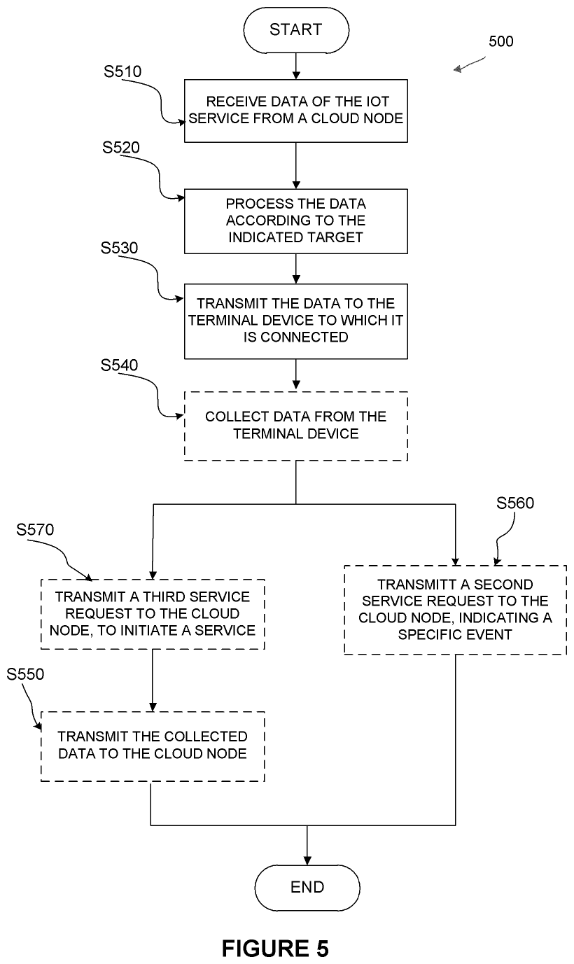

FIG. 5 illustratively shows a flowchart of a method 500 for communicating an IoT service with a terminal device at an IoT network device to which the terminal device is connected. In an embodiment, the method 500 may be performed at the network domain.

As shown in FIG. 5, the method 500 may include blocks S510˜S570.

The method 500 starts at block S510, where data of the IoT service is received from a cloud node. The method then proceeds to block S520 to transmit the data to the terminal device to which it is connected.

In an embodiment of the present disclosure, the data of the IoT service may indicate a terminal device as a target. For example, the IoT network device may support a plurality of terminal devices, and only a certain kind of terminal devices are involved in the IoT service. For example, the IoT network device may connect an Accelerometer, a Thermometer, a Hygrometer, A gyroscope, an Ambient Light detector, a MEMS microphone, a Magnetometer, and a Barometer. The IoT service is a weather application, and only the thermometer and the hygrometer are involved in the application. The IoT service thus may indicate the thermometer and the hygrometer as the target of the service. The method 500 may comprise block S530 of processing the data according to the indicated target. Different terminal devices may operate under different mechanism or rules. The IoT network device shall process the data from the cloud node into data that is suitable to the terminal devices to which it connects, so that all the terminal devices may properly join in the service via the IoT network device. In such case, block S520 is to transmit the processed data to the determined terminal device.

In an embodiment of the present disclosure, the method 500 may further comprise block S540 of collecting data from the terminal device, and block S550 of transmitting the collected data to the cloud node. For example, the IoT service is a traffic service, and needs to collect the position information of all vehicles in a specific city. The IoT network device, upon receiving data of the service from the serving node, knows that it needs to collect position information by analyzing the received service data. Then the IoT network device may initiate a location sensor to which it connects to sense the location, and transmits the position information to the cloud node which provides the traffic service. In the embodiment of the present disclosure, the method 500 may further comprise an operation of processing the collected data according to the service and transmitted the processed collected data to the cloud node. Different terminal devices may operate under different mechanism or rules. The data collected from the terminal device may need to be converted in terms of protocol or other aspects, to be transmitted to the cloud node. In an example, the IoT network device may process the collected data into a protocol agreed between the cloud node and the IoT network device, so that the cloud node may correctly understand the data.

In an embodiment of the present disclosure, the method 500 may further comprise block S560 of transmitting a second service request to the cloud node. The second service request indicates a specific event. In some cases, the terminal device data collected by the IoT network device indicates a specific event, such as a malfunction of the terminal device, an unauthorized usage of a device, an abnormal condition, and others. For example, a temperature sensor in a room temperature reports a temperature of −20 Celsius degrees, which might mean that the temperature sensor may fail. As another example, a temperature sensor in a room temperature reports a temperature of 90 Celsius degrees, which indicates that there may be a fire near the temperature sensor. In an embodiment of the present disclosure, the IoT network device has at least one of usage information of the terminal device and state information of the terminal device. When receiving terminal device data from the terminal device, the IoT network device may determine whether a specific event occurs. If a specific event occurs, the IoT network device transmits a second service request to the cloud node, indicating the specific event. The cloud node which receives the second service request may initiate a corresponding second service to handle the event. For example, if a plurality of second service requests is received indicating the temperature around a place is higher than 80 Celsius degrees, the cloud node may initiate a fire alarm service to inform the fire. For example, a message indicating the place and the range of the fire may be transmitted to a fire control center. As another example, if the cloud node receives a second service request indicating a malfunction of the temperature sensor, the cloud node may initiate an alarm service. The IoT network device may then flicker or show a message on its display to indicate the malfunction of the temperature sensor to a user of the temperature sensor, who may replace the temperature sensor.

In an embodiment of the present disclosure, the method 500 may further comprise, prior to block S550, block S570 of transmitting a third service request to the cloud node to initiate a service. The third service request includes at least an identification of a service, an identification of the terminal device, and an identification of the IoT network device. The cloud node that receives the third service request may initiate an authentication process to verify whether the IoT network device and the terminal device are allowed to initiate a service. If an approval of the service is received in response to the transmission of the third service request, the method 500 proceeds to block S550 to transmit the collected data to the cloud node to initiate a service.

Regarding the authentication process between the IoT network device and the cloud node, FIG. 4 shows an exemplifying signaling diagram illustrating details of the authentication process according to an embodiment of the present disclosure. When a terminal device or an IoT network device initially connects to the IoT network, it initiates an authentication process. In another case, when a terminal device transmits data to the cloud node via the IoT network device to activate a specific service, an authentication process is needed before the specific service is activated. As shown in FIG. 4, in block S410, the IoT network device transmits a first authentication request including at least an identification of the IoT network device and an identification of the terminal device to the cloud node. In an embodiment of the present disclosure, the IoT network device may further comprise a profile of a service provider (or a service), and include the profile of the service provider in the first authentication request, to indicate an authentication aiming at the specific service provider (or, a specific service). Then in block S420, the cloud node performs an authentication on the first authentication request. The IoT network device receives an authentication result in response to the transmission of the first authentication request in block S430. If the authentication result indicates a successful authentication, the terminal device and the IoT network device are allowed to anticipate in the service. With the authentication process, only verified terminal devices and IoT network devices are allowed to get access the service. For example, a stolen cell phone cannot register to applications. The IoT network device may enter an inactive state (S440) and indicate the inactive state to the terminal device in case that the authentication result indicates a failed authentication. In an embodiment of the present disclosure, if the authentication result indicates an unsuccessful authentication, the authentication result may comprise a Disable command to disable the terminal device. For example, a stolen cell phone may be disabled with the Disable command included in the authentication result. As another example, the cloud node may transmit, in block S450, a Re-authentication indication to the IoT network device after transmitting the Disable command. In some cases, the first unsuccessful authentication may be resulted from some abnormal situations. For example, a malfunction of the terminal device may result in unsuccessful authentication. The cloud node may transmit a Re-authentication indication to invite another authentication process. The IoT network device may reactivate for a short period in the inactive state. In the case that a re-authentication indication is received during the re-activating period, the IoT network device may transmit, in block S460, a second authentication request including an identification of the IoT network device and an identification of the terminal device to the cloud node and receive an authentication result in response to the transmission of the second authentication request. For example, after recovery of the terminal device, the IoT network device that receives the Re-authentication indication may re-transmit an authentication request including the identification of the IoT network device and the identification of the terminal device to the cloud node, to request authentication on the IoT network and the terminal device.

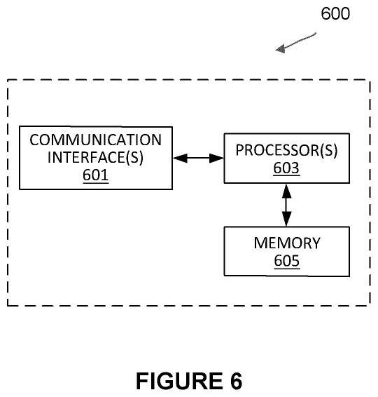

Hereinafter, a structure of an NF entity 600 will be described with reference to FIG. 6. FIG. 6 illustratively shows a schematic structure diagram of an NF entity 600 according to an exemplary embodiment of the present disclosure. The NF entity 600 in FIG. 6 may perform the method 300 for providing an IoT service described previously with reference to FIG. 3. Accordingly, some detailed description on the NF entity 600 may refer to the corresponding description of the method 400 as previously discussed.

As shown in FIG. 6, the NF entity 600 may include at least one controller or processor 603 including e.g., any suitable Central Processing Unit, CPU, microcontroller, Digital Signal Processor, DSP, etc., capable of executing computer program instructions. The computer program instructions may be stored in a memory 605. The memory 605 may be any combination of a RAM (Random Access Memory) and a ROM (Read Only Memory). The memory may also comprise persistent storage, which, for example, can be any single one or combination of magnetic memory, optical memory, or solid state memory or even remotely mounted memory. The exemplary NF entity 600 further comprises a communication interface 601 arranged for communication.

The instructions, when loaded from the memory 605 and executed by the at least one processor 603, may cause the NF entity 600 to perform the method 300 as previously described.

In particular, the instructions, when loaded from the memory 605 and executed by the at least one processor 603, may cause the NF entity 600 to receive a first service request to invoke at least one service is received. The first service request may come from a service provider to invoke a service offered in the IoT network.

The instructions, when loaded from the memory 605 and executed by the at least one processor 603, may cause the NF entity 600 to select one of the plurality of cloud nodes as the serving node for the at least one service based on the first service request. In an embodiment, the first service request may comprise the identification of the at least one service to be invoked, or an identification of the service provider. Each cloud node is mapped to/assigned with a specific type of service. Accordingly, the corresponding cloud node that is involved in the at least one service may be determined based on the first service request. In another example, the first service request may invoke more than one service, which may result in selection of more than one cloud nodes. In an embodiment of the present disclosure, each service may have its own catalog/index. A catalog/index of the at least one service may be determined and then one of the plurality of cloud nodes is selected based on the catalog/index of the at least one service.

The instructions, when loaded from the memory 605 and executed by the at least one processor 603, may cause the NF entity 600 to determine one or more IoT network device to receive the data least one service based on the first service request. According to the at least one service indicated by the first service request, the terminal devices that are involved in the at least one service may be determined. In the cloud computing environment, information on IoT network devices and on terminal devices has been previously stored. For example, when an IoT network device initially connects to the IoT network, it will transmit to the cloud computing environment its information and information on terminal devices that connect to it. Alternatively, when a new terminal device is connected to the network by connecting to an IoT network device, the IoT network device to which it connects will transmit its information and information on that terminal device to the cloud computing environment. When a service is initially established/provided in the IoT network, the cloud computing environment may analyze the service to determine the terminal devices (and also the IoT network devices) that may be involved in the service. Then, the relationship between the service and the terminal devices and also the IoT network devices is established. The relationship may be a mapping table, a manifest, a file, and others. It is not limited in the present disclosure. When the at least one service is to be invoked upon receiving the first service request, the IoT network device to receive data of the at least one service can be determined based on the relationship.

The instructions, when loaded from the memory 605 and executed by the at least one processor 603, may cause the NF entity 600 to transmit data of the at least one service from the serving node to the determined IoT network device. In the present disclosure, the IoT network device is connected to one or more terminal device which uses the data of the at least one service.

In an embodiment of the present disclosure, the instructions, when loaded from the memory 605 and executed by the at least one processor 603, may cause the NF entity 600 to generate data of the at least one service according to a protocol agreed between the serving node and the IoT network device. By using a uniform protocol between the cloud node and the IoT network device, there is no more intermediate elements needed for the IoT network device correctly receiving the data. For example, no gateway is needed for protocol conversion. The cloud computing environment has an intensive computing and processing capability. The present disclosure makes use of that capability of the cloud domain to flatten the network.

In an embodiment of the present disclosure, the first service request may indicate specific terminal device functions for the at least one service. For example, the first service request is to invoke a traffic service, and is to broadcast traffic regulation messages to a specific city. The cloud node that is assigned with the traffic service is selected from the plurality of cloud nodes. The IoT network devices that are in the specific city and connect to vehicle navigators may be determined to receive the traffic regulation messages. The traffic regulation messages are then transmitted from the cloud node to the IoT network devices, which will display the received messages on the display of the vehicle navigators to which they connect.

In an embodiment of the present disclosure, the instructions, when loaded from the memory 605 and executed by the at least one processor 603, may cause the NF entity 600 to receive terminal device data from the IoT network device for the at least one service. The terminal device data is collected by the IoT network device from the terminal device to which it connects. For example, the first service request is to invoke a traffic service, and needs to collect the position information of all vehicles in a specific city. The IoT network device, upon receiving data of the service from the serving node, knows that it needs to collect position information by analyzing the received service data. Then the IoT network device may initiate a location sensor to which it connects to sense the location, and transmits the position information to the cloud node which provides the traffic service. In the embodiment of the present disclosure, the instructions, when loaded from the memory 605 and executed by the at least one processor 603, may cause the NF entity 600 to process the terminal device data according to the at least one service. For example, the cloud node which receives the position information from the IoT network device may process and analyze all the position information from IoT network devices in a specific city, to generate a traffic analysis result or a traffic jam analysis. The cloud node may also report the processed result to the service provider.

In an embodiment of the present disclosure, the instructions, when loaded from the memory 605 and executed by the at least one processor 603, may cause the NF entity 600 to receive a second service request from the IoT network device. The second service request indicates a specific event. The instructions, when loaded from the memory 605 and executed by the at least one processor 603, may cause the NF entity 600 to initiate a second service based on the second service request. In some cases, the terminal device data collected by the IoT network device indicates a specific event, such as a malfunction of the terminal device, an unauthorized usage of a device, an abnormal condition, and others. For example, a temperature sensor in a room temperature reports a temperature of −20 Celsius degrees, which might mean that the temperature sensor may fail. As another example, a temperature sensor in a room temperature reports a temperature of 90 Celsius degrees, which indicates that there may be a fire near the temperature sensor. In an embodiment of the present disclosure, the IoT network device has at least one of usage information of the terminal device and state information of the terminal device. When receiving terminal device data from the terminal device, the IoT network device may determine whether a specific event occurs. If a specific event occurs, the IoT network device transmits a second service request to the cloud node, indicating the specific event. The cloud node which receives the second service request may initiate a corresponding second service to handle the event. For example, if a plurality of second service requests is received indicating the temperature around a place is higher than 80 Celsius degrees, the cloud node may initiate a fire alarm service to inform the fire. For example, a message indicating the place and the range of the fire may be transmitted to a fire control center. As another example, if the cloud node receives a second service request indicating a malfunction of the temperature sensor, the cloud node may initiate an alarm service. The IoT network device may then flicker or show a message on its display to indicate the malfunction of the temperature sensor to a user of the temperature sensor, who may replace the temperature sensor.

In an embodiment of the present disclosure, the instructions, when loaded from the memory 605 and executed by the at least one processor 603, may cause the NF entity 600 to perform an authentication process between the cloud node and the IoT network device. FIG. 4 shows an exemplifying signaling diagram illustrating details of the authentication process according to an embodiment of the present disclosure. When a terminal device or an IoT network device initially connects to the IoT network, it initiates an authentication process. In another case, when a terminal device transmits data to the cloud node via the IoT network device to activate a specific service, an authentication process is needed before the specific service is activated.

As shown in FIG. 4, the instructions, when loaded from the memory 605 and executed by the at least one processor 603, may cause the NF entity 600 to receive a first authentication request including at least an identification of the IoT network device and an identification of the terminal device from the IoT network device. In an embodiment of the present disclosure, the IoT network device may further comprise a profile of a service provider (or a service), and include the profile of the service provider in the first authentication request, to indicate an authentication aiming at the specific service provider (or, a specific service). Then the instructions, when loaded from the memory 605 and executed by the at least one processor 603, may further cause the NF entity 600 to perform an authentication on the first authentication request, and transmit an authentication result to the IoT network device. If the authentication result indicates a successful authentication, the terminal device and the IoT network device are allowed to anticipate in the service. With the authentication process, only verified terminal devices and IoT network devices are allowed to get access the service. For example, a stolen cell phone cannot register to applications. The IoT network device may enter an inactive state and indicate the inactive state to the terminal device in case that the authentication result indicates a failed authentication. If the authentication result indicates an unsuccessful authentication, the authentication result may comprise a Disable command to disable the terminal device. For example, a stolen cell phone may be disabled with the Disable command included in the authentication result. As another example, the cloud node may transmit a Re-authentication indication to the IoT network device after transmitting the Disable command. In some cases, the first unsuccessful authentication may be resulted from some abnormal situations. For example, a malfunction of the terminal device may result in unsuccessful authentication. The instructions, when loaded from the memory 605 and executed by the at least one processor 603, may cause the NF entity 600 to transmit a Re-authentication indication to invite another authentication process. The IoT network device may reactivate for a short period in the inactive state. In the case that a re-authentication indication is received during the re-activating period, the IoT network device may transmit a second authentication request including an identification of the IoT network device and an identification of the terminal device to the cloud node and receive an authentication result in response to the transmission of the second authentication request. For example, after recovery of the terminal device, the IoT network device that receives the Re-authentication indication may re-transmit an authentication request including the identification of the IoT network device and the identification of the terminal device to the cloud node, to request authentication on the IoT network and the terminal device.

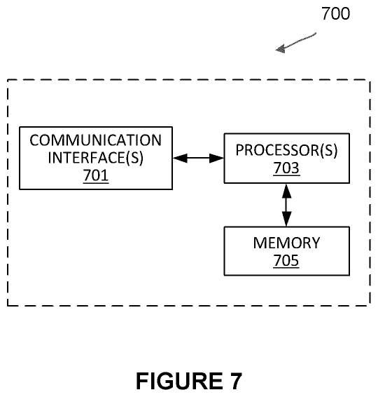

Hereinafter, a structure of an NF entity will be described with reference to FIG. 7. FIG. 7 illustratively shows a schematic structure diagram of an NF entity 700 according to an exemplary embodiment of the present disclosure. The NF entity 700 in FIG. 7 may perform the method 500 for described previously with reference to FIG. 5. Accordingly, some detailed description on the NF entity 700 may refer to the corresponding description of the method 500 as previously discussed.

As shown in FIG. 7, the NF entity 700 may include at least one controller or processor 703 including e.g., any suitable Central Processing Unit, CPU, microcontroller, Digital Signal Processor, DSP, etc., capable of executing computer program instructions. The computer program instructions may be stored in a memory 705. The memory 705 may be any combination of a RAM (Random Access Memory) and a ROM (Read Only Memory). The memory may also comprise persistent storage, which, for example, can be any single one or combination of magnetic memory, optical memory, or solid-state memory or even remotely mounted memory. The exemplary NF entity 700 further comprises a communication interface 1001 arranged for communication.

The instructions, when loaded from the memory 705 and executed by the at least one processor 703, may cause the NF entity 700 to perform the method 500 as previously described.

In particular, the instructions, when loaded from the memory 705 and executed by the at least one processor 703, may cause the NF entity 700 to receive data of the IoT service from a cloud node. The instructions, when loaded from the memory 705 and executed by the at least one processor 703, may further cause the NF entity 700 to transmit the data to the terminal device to which it is connected.

In an embodiment of the present disclosure, the data of the IoT service may indicate a terminal device as a target. For example, the IoT network device may support a plurality of terminal devices, and only a certain kind of terminal devices are involved in the IoT service. For example, the IoT network device may connect an Accelerometer, a Thermometer, a Hygrometer, A gyroscope, an Ambient Light detector, a MEMS microphone, a Magnetometer, and a Barometer. The IoT service is a weather application, and only the thermometer and the hygrometer are involved in the application. The IoT service thus may indicate the thermometer and the hygrometer as the target of the service. In an embodiment of the present disclosure, the instructions, when loaded from the memory 705 and executed by the at least one processor 703, may cause the NF entity 700 to process the data according to the indicated target. Different terminal devices may operate under different mechanism or rules. The IoT network device shall process the data from the cloud node into data that is suitable to the terminal devices to which it connects, so that all the terminal devices may properly join in the service via the IoT network device. In such case, the NF entity 700 is caused to transmit the processed data to the determined terminal device.

In an embodiment of the present disclosure, the instructions, when loaded from the memory 705 and executed by the at least one processor 703, may cause the NF entity 700 to collect data from the terminal device, and transmit the collected data to the cloud node. For example, the IoT service is a traffic service, and needs to collect the position information of all vehicles in a specific city. The IoT network device, upon receiving data of the service from the serving node, knows that it needs to collect position information by analyzing the received service data. Then the IoT network device may initiate a location sensor to which it connects to sense the location, and transmits the position information to the cloud node which provides the traffic service. In an embodiment of the present disclosure, the instructions, when loaded from the memory 705 and executed by the at least one processor 703, may cause the NF entity 700 to process the collected data according to the service and transmitted the processed collected data to the cloud node. Different terminal devices may operate under different mechanisms or rules. The data collected from the terminal device may need to be converted in terms of protocol or other aspects, to be transmitted to the cloud node. In an example, the IoT network device may process the collected data into a protocol agreed between the cloud node and the IoT network device, so that the cloud node may correctly understand the data.

In an embodiment of the present disclosure, the instructions, when loaded from the memory 705 and executed by the at least one processor 703, may cause the NF entity 700 to transmit a second service request to the cloud node. The second service request indicates a specific event. In some cases, the terminal device data collected by the IoT network device indicates a specific event, such as a malfunction of the terminal device, an unauthorized usage of a device, an abnormal condition, and others. For example, a temperature sensor in a room temperature reports a temperature of −20 Celsius degrees, which might mean that the temperature sensor may fail. As another example, a temperature sensor in a room temperature reports a temperature of 90 Celsius degrees, which indicates that there may be a fire near the temperature sensor. In an embodiment of the present disclosure, the IoT network device has at least one of usage information of the terminal device and state information of the terminal device. When receiving terminal device data from the terminal device, the IoT network device may determine whether a specific event occurs. If a specific event occurs, the IoT network device transmits a second service request to the cloud node, indicating the specific event. The cloud node which receives the second service request may initiate a corresponding second service to handle the event. For example, if a plurality of second service requests is received indicating the temperature around a place is higher than 80 Celsius degrees, the cloud node may initiate a fire alarm service to inform the fire. For example, a message indicating the place and the range of the fire may be transmitted to a fire control center. As another example, if the cloud node receives a second service request indicating a malfunction of the temperature sensor, the cloud node may initiate an alarm service. The IoT network device may then flicker or show a message on its display to indicate the malfunction of the temperature sensor to a user of the temperature sensor, who may replace the temperature sensor.

In an embodiment of the present disclosure, the instructions, when loaded from the memory 705 and executed by the at least one processor 703, may cause the NF entity 700 to transmit a third service request to the cloud node. The third service request includes at least an identification of a service, an identification of the terminal device, an identification of the IoT network device. The cloud node that receives the third service request may initiate an authentication process to verify whether the IoT network device and the terminal device are allowed to initiate a service. If an approval of the service is received in response to the transmission of the third service request, the NF entity is caused to transmit the collected data to the cloud node to initiate a service.

Regarding the authentication process between the IoT network device and the cloud node, FIG. 4 shows an exemplifying signaling diagram illustrating details of the authentication process according to an embodiment of the present disclosure. When a terminal device or an IoT network device initially connects to the IoT network, it initiates an authentication process. In another case, when a terminal device transmits data to the cloud node via the IoT network device to activate a specific service, an authentication process is needed before the specific service is activated. As shown in FIG. 4, the instructions, when loaded from the memory 705 and executed by the at least one processor 703, may cause the NF entity 700 to transmit a first authentication request including at least an identification of the IoT network device and an identification of the terminal device to the cloud node. In an embodiment of the present disclosure, the first authentication request may include a profile of a service provider, to indicate an authentication aiming at the specific service provider (or, a specific service). Then the cloud node performs an authentication on the first authentication request. The instructions, when loaded from the memory 705 and executed by the at least one processor 703, may cause the NF entity 700 to receive an authentication result in response to the transmission of the first authentication request. If the authentication result indicates a successful authentication, the terminal device and the IoT network device are allowed to anticipate in the service. With the authentication process, only verified terminal devices and IoT network devices are allowed to get access the service. For example, a stolen cell phone cannot register to applications. The IoT network device may enter an inactive state and indicate the inactive state to the terminal device in case that the authentication result indicates a failed authentication. If the authentication result indicates an unsuccessful authentication, the authentication result may comprise a Disable command to disable the terminal device. For example, a stolen cell phone may be disabled with the Disable command included in the authentication result. As another example, the cloud node may transmit a Re-authentication indication to the IoT network device after transmitting the Disable command. In some cases, the first unsuccessful authentication may be resulted from some abnormal situations. For example, a malfunction of the terminal device may result in unsuccessful authentication. The cloud node may transmit a Re-authentication indication to invite another authentication process. In an embodiment of the present disclosure, the instructions, when loaded from the memory 705 and executed by the at least one processor 703, may cause the NF entity 700 to reactivate for a short period in the inactive state. In the case that a re-authentication indication is received during the re-activating period, the instructions, when loaded from the memory 705 and executed by the at least one processor 703, may cause the NF entity 700 to transmit a second authentication request including an identification of the IoT network device and an identification of the terminal device to the cloud node and receive an authentication result in response to the transmission of the second authentication request. For example, after recovery of the terminal device, the IoT network device that receives the Re-authentication indication may re-transmit an authentication request including the identification of the IoT network device and the identification of the terminal device to the cloud node, to request authentication on the IoT network and the terminal device.

Also included in the NF entity 600 or 700 is a suitable power supply block, which may include AC/DC power conversion to provide power for the NF entity. It should be appreciated that the actual power architecture for the NF entity may vary by the hardware platform used, e.g., depending upon the core SoC (System on Chip), memory, analog front-end, analog signal chain components and interfaces used in the specific platform, and the like.

NF entity 600 or 700 may comprise other circuits, subsystems, component, and structures that are necessary for implementing the desired functions, which are not shown in detail in order not to obscure the understanding of the example embodiments.

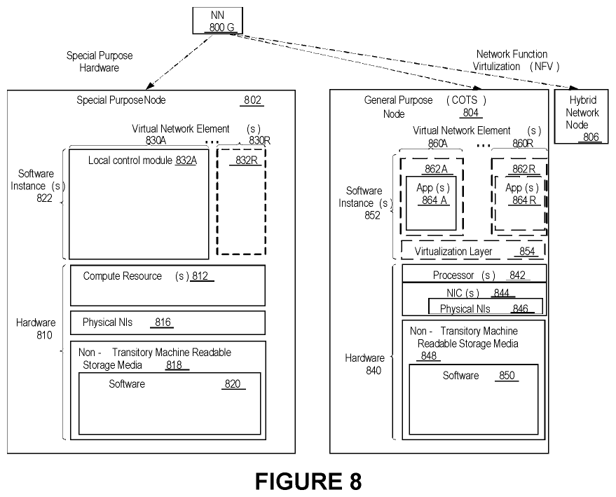

FIG. 8 illustrates three exemplary implementations of a network node (NN) according to the present disclosure.

Two of the NN implementations in FIG. 8 are: 1) a special-purpose network node 802 that uses custom processing circuits such as application-specific integrated-circuits (ASICs) and a proprietary operating system (OS); and 2) a general purpose network node 804 that uses common off-the-shelf (COTS) processors and a standard OS which has been configured to provide one or more of the features or functions disclosed herein.

The special-purpose network node 802 includes hardware 810 comprising compute resource(s) 812 (which typically include a set of one or more processors), and physical network interfaces (NIs) 816 (sometimes called physical ports), as well as non-transitory machine readable storage media 818 having stored therein software 820. A physical NI is hardware in a NN through which a network connection is made (e.g., wirelessly through a wireless network interface controller (WNIC) or through plugging in a cable to a physical port connected to a network interface controller (NIC)). During operation, the software 820 may be executed by the hardware 810 to instantiate a set of one or more software instance(s) 822. Each of the software instance(s) 822, and that part of the hardware 810 that executes that software instance (be it hardware dedicated to that software instance, hardware in which a portion of available physical resources (e.g., processor cores in a multi-core processor) is used, and/or time slices of hardware temporally shared by that software instance with others of the software instance(s) 822), form a separate virtual network element 830A-R. Each of the virtual network element(s) (VNEs) 830A-R includes a local control module 832A-R such that a given virtual network element (e.g., 830A) includes the local control module (e.g., 832A), and that portion of the hardware 810 that executes the virtual network element (e.g., 830A).

The local control module may comprise for example, modules for implementing a cloud node according to the present disclosure. In an embodiment, the local control module may be implemented to, for example, provide a specific service in the IoT network.

Returning to FIG. 8, the general purpose network node 804 includes hardware 840 comprising a set of one or more processor(s) 842 (which are often COTS processors) and network interface controller(s) 844 (NICs; also known as network interface cards) (which include physical NIs 846), as well as non-transitory machine readable storage media 848 having stored therein software 850. During operation, the processor(s) 842 execute the software 850 to instantiate one or more sets of one or more applications 864A-R. While one embodiment does not implement virtualization, alternative embodiments may use different forms of virtualization—represented by a virtualization layer 854 and software containers 862A-R. For example, one such alternative embodiment implements operating system-level virtualization, in which case the virtualization layer 854 represents the kernel of an operating system (or a shim executing on a base operating system) that allows for the creation of multiple software containers 862A-R that may each be used to execute one of the sets of applications 864A-R. In this embodiment, the multiple software containers 862A-R (also called virtualization engines, virtual private servers, or jails) are each a user space instance (typically a virtual memory space); these user space instances are separate from each other and separate from the kernel space in which the operating system is run; the set of applications running in a given user space, unless explicitly allowed, cannot access the memory of the other processes. Another such alternative embodiment implements full virtualization, in which case: 1) the virtualization layer 854 represents a hypervisor (sometimes referred to as a virtual machine monitor (VMM)) or a hypervisor executing on top of a host operating system; and 2) the software containers 862A-R each represent a tightly isolated form of software container called a virtual machine that is run by the hypervisor and may include a guest operating system. A virtual machine is hardware implemented software that is run on a physical machine that allows the hardware of the physical machine to be used as multiple separate machines or to provide hardware functionality for hardware that is not actually present within the physical machine. Applications generally do not know they are running on a virtual machine as opposed to running on a “bare metal” host electronic device, though some systems provide para-virtualization which allows an operating system or application to be aware of the presence of virtualization for optimization purposes.

The instantiation of the one or more sets of one or more applications 864A-R, as well as the virtualization layer 854 and software containers 862A-R if implemented, are collectively referred to as software instance(s) 852. Each set of applications 864A-R, corresponding software container 862A-R if implemented, and that part of the hardware 840 that executes them (be it hardware dedicated to that execution and/or time slices of hardware temporally shared by software containers 862A-R), forms a separate virtual network element(s) 860A-R.

The virtual network element(s) 860A-R perform similar functionality to the virtual network element(s) 830A-R. This virtualization of the hardware 840 is sometimes referred to as network function virtualization (NFV)). Thus, NFV may be used to consolidate many network equipment types onto industry standard high volume server hardware, physical switches, and physical storage, which could be located in for example data centers and customer premise equipment (CPE). However, different embodiments of the disclosure may implement one or more of the software container(s) 862A-R differently. For example, while embodiments of the disclosure are illustrated with each software container 862A-R corresponding to one VNE 860A-R, alternative embodiments may implement this correspondence at a finer level granularity; it should be understood that the techniques described herein with reference to a correspondence of software containers 862A-R to VNEs also apply to embodiments where such a finer level of granularity is used.

The third exemplary NN implementation in FIG. 8 is a hybrid network node 806, which includes both custom ASICs/proprietary OS and COTS processors/standard OS in a single NN or a single card within an NN. In certain embodiments of such a hybrid network node, a platform virtual machine (VM), such as a VM that that implements the functionality of the special-purpose network node 802, could provide for para-virtualization to the hardware present in the hybrid network node 806.

The above described term “network node” may refer to any node/device capable of communicating with each other (or even being combinable with each other) to implement the method of the present disclosure, especially method 300 as described above in conjunction with FIG. 3.

The foregoing description of implementations provides illustration and description, but is not intended to be exhaustive or to limit the disclosure to the precise form disclosed. Modifications and variations are possible in light of the above teachings, or may be acquired from practice of the disclosure.

Aspects of the disclosure may also be embodied as methods and/or computer program products. Accordingly, the disclosure may be embodied in hardware and/or in hardware/software (including firmware, resident software, microcode, etc.). Furthermore, the embodiments may take the form of a computer program product on a computer-usable or computer-readable storage medium having computer-usable or computer-readable program code embodied in the medium for use by or in connection with an instruction execution system. Such instruction execution system may be implemented in a standalone or distributed manner. The actual software code or specialized control hardware used to implement embodiments described herein is not limiting of the disclosure. Thus, the operation and behavior of the aspects were described without reference to the specific software code, it being understood that those skilled in the art will be able to design software and control hardware to implement the aspects based on the description herein.

Furthermore, certain portions of the disclosure may be implemented as “logic” that performs one or more functions. This logic may include hardware, such as an application specific integrated circuit or field programmable gate array or a combination of hardware and software.

It should be emphasized that the term “comprises/comprising” when used in this specification is taken to specify the presence of stated features, integers, steps, blocks, components or groups but does not preclude the presence or addition of one or more other features, integers, steps, blocks, components or groups thereof.

No element, act, or instruction used in the disclosure should be construed as critical or essential to the disclosure unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

The foregoing description gives only the embodiments of the present disclosure and is not intended to limit the present disclosure in any way. Thus, any modification, substitution, improvement or like made within the spirit and principle of the present disclosure should be encompassed by the scope of the present disclosure.

1-44. (canceled)

45. A method for providing an Internet of Things (IoT) service from a cloud node to an IoT network device in a cloud computing environment comprising a plurality of cloud nodes, the method comprising:
receiving a first service request to invoke at least one service;
selecting one of the plurality of cloud nodes as a serving node for the at least one service based on the first service request;
determining an IoT network device to receive the at least one service based on the first service request; and
transmitting data of the at least one service from the serving node to the determined IoT network device;
wherein the IoT network device is connected to one or more terminal devices which use the data of the at least one service.

46. The method according to claim 45, wherein the first service request is from a service provider, wherein each of the plurality of cloud nodes is assigned with a specific type of service, and/or wherein the first service request indicates specific terminal device functions for the at least one service.

47. The method according to claim 45, further comprising receiving terminal device data from the IoT network device for the at least one service, wherein the terminal device data is collected by the IoT network device from the one or more terminal devices to which the IoT network device connects.

48. The method according to claim 47, further comprising processing the terminal device data according to the at least one service.

49. The method according to claim 45, further comprising:
receiving a second service request from the IoT network device, which second service request indicates a specific event; and
initiating a second service based on the second service request.

50. The method according to claim 45, wherein the IoT network device has a profile of a service provider, and/or wherein the IoT network device has at least one of: usage information of the one or more terminal devices and state information of the one or more terminal devices.

51. The method according to claim 45, further comprising, prior to transmitting the data of the at least one service to the IoT network device:
generating data of the at least one service according to a protocol agreed between the serving node and the IoT network device.

52. The method according to claim 45, wherein selecting one of the plurality of cloud nodes as the serving node comprises:
determining a catalog/index of the at least one service; and
selecting one of the plurality of cloud nodes based on the catalog/index of the at least one service.

53. The method according to claim 45, further comprising:
receiving a first authentication request including at least an identification of the IoT network device and an identification of a terminal device from the IoT network device,
performing an authentication on the first authentication request, and
transmitting an authentication result to the IoT network device.

54. The method according to claim 53, wherein the authentication result comprises a Disable command to disable the terminal device identified by the identification, and the method further comprising:
transmitting a Re-authentication indication to the IoT network device after transmitting the Disable command.

55. A method for communicating an Internet of Things (IoT) service with a terminal device at an IoT network device to which the terminal device is connected, the method comprising:
receiving data of the IoT service from a cloud node; and
transmitting the data to the terminal device to which the IoT network device is connected.

56. The method according to claim 55, wherein the data of the IoT service indicates a terminal device as a target, and the method further comprises:
processing the data according to the indicated target; and
transmitting the processed data to the target terminal device.

57. The method according to claim 56, wherein the terminal device comprises at least one of an Accelerometer, a Thermometer, a Hygrometer, A gyroscope, an Ambient Light detector, a MEMS microphone, a Magnetometer, and a Barometer.

58. The method according to claim 55, further comprising:
collecting data from the terminal device; and
transmitting the collected data to the cloud node.

59. The method according to claim 58, further comprising:
transmitting a second service request to the cloud node, which second service request indicates a specific event.

60. The method according to claim 58, further comprising, prior to transmitting the collected data:
transmitting a third service request to the cloud node, which third service request includes at least an identification of a service, an identification of the terminal device, and an identification of the IoT network device, and
transmitting the collected data if an approval of the service is received in response to the transmission of the third service request.

61. The method according to claim 55, further comprising:
transmitting a first authentication request including at least an identification of the IoT network device and an identification of the terminal device to the cloud node, and
receiving an authentication result in response to the transmission of the first authentication request.

62. The method according to claim 61, further comprising:
entering an inactive state and indicating the inactive state to the terminal device in case that the authentication result indicates a failed authentication.

63. The method according to claim 62, further comprising:
re-activating for a short period in the inactive state; and
in the case that a re-authentication indication is received during the re-activating period, transmitting a second authentication request including an identification of the IoT network device and an identification of the terminal device to the cloud node and receiving an authentication result in response to the transmission of the second authentication request.

64. A Network Function (NF) entity for providing an Internet of Things (IoT) service from a cloud node to an IoT network device in a cloud computing environment comprising a plurality of cloud nodes, the NF entity comprising:
a communication interface arranged for communication;
at least one processor; and
a memory comprising instructions which, when executed by the at least one processor, cause the NF entity to:
receive a first service request to invoke at least one service;
select one of the plurality of cloud nodes as a serving node for the at least one service based on the first service request;
determine an IoT network device to receive the at least one service based on the first service request; and
transmit data of the at least one service from the serving node to the determined IoT network device;
wherein the IoT network device is connected to one or more terminal devices which use the data of the at least one service.
